(19) United States
(12) Patent Application Publication
(10) Pub. No.: US 2005/0102255 A1
(43) Pub. Date: May 12, 2005

(54) Computer-implemented system and method for handling stored data

(76) Inventor: David C. Bultman, Cary, NC (US)

Correspondence Address: John V. Biernacki;Jones Day, North Point, 901 Lakeside Avenue, Cleveland, OH, 44114, US

(21) Appl. No.: 10/702,367

(22) Filed: Nov. 6, 2003

(51) Int. Cl. G06F 7/00

(52) U.S. Cl. 707/1

(57) ABSTRACT

A computer-implemented B-tree structure for information processing. The B-tree structure is used with any storage mechanism that can hold a plurality of data records. The B-tree includes interconnected nodes having a root node, index nodes and leaf nodes. The B-tree structure allows for the data records to be associated with duplicate keys that are stored separate from the leaf nodes.

### BACKGROUND

1. Technical Field

The present invention is generally directed to handling data within a computer-implemented environment, and more particularly to storing and accessing data contained in a computer-implemented environment.

2. Description of the Related Art

B-trees are an accepted and widespread practice for providing large-scale key-value pair lookup. As an example, a traditional B-tree is shown at reference number 30 in FIG. 1. In the B-tree 30, its uppermost level 32 is referred to as the head node with intermediate index nodes 34 following. The index nodes 34 have pointers (e.g., pointer shown at reference number 36) to another node. At the next level, the leaf nodes 40 contain the data. The leaf nodes 40 have pointers (e.g., 42) to the next and previous leaf nodes. In this example, the values for two index nodes (50, 52) and eight leaf nodes (60, 62, 64, 66, 68, 70, 72, 74) are shown.

FIG. 1 illustrates how searching can be performed in a traditional B-tree. In this example, the B-tree 30 of FIG. 1 is an index to a database file, and the key values in each node correspond to a key value field in a data record of the database file. To locate data records with a key value field value less than or equal to “10”, a first pointer 82 is traversed from the root node 32. To locate data records with a key value field value greater than “30” and less than or equal to “80”, a second pointer 90 from the root node 32 is followed. To locate the data record corresponding to the key value “51” shown at 92, pointers (90, 36) can be followed from the root node 32 through the index node 50 to the leaf node 68. The key values in the leaf node 68 are searched until the key value “51” (shown at 92) is found. Once found, the record identifier value corresponding to the key is used to locate the data record.

There are inefficiencies with such an approach, such as when multiple processes attempt to concurrently access the B-tree. When a page of key-value data entries is accessed, it is typically locked by the requester to ensure that it is not concurrently modified by other users of the page. To modify the page, it is locked in an exclusive mode. This may lead to sizable queues of transactions that are waiting to obtain access to the page. As an illustration, if thread A wanted to update one key-value pair while thread B attempted to update or read a different value with the same key, the operation cannot take place until thread A has completed.

### SUMMARY

In accordance with the teachings disclosed herein, a computer-implemented B-tree structure is provided for information processing involving a database system with a plurality of data records. The B-tree includes interconnected nodes having a root node, index nodes and leaf nodes. The B-tree structure allows for the data records to be associated with duplicate keys that are stored separate from the leaf nodes.

### BRIEF DESCRIPTION OF THE DRAWINGS

FIG. 1 is a B-tree diagram which illustrates a searching approach of the prior art;

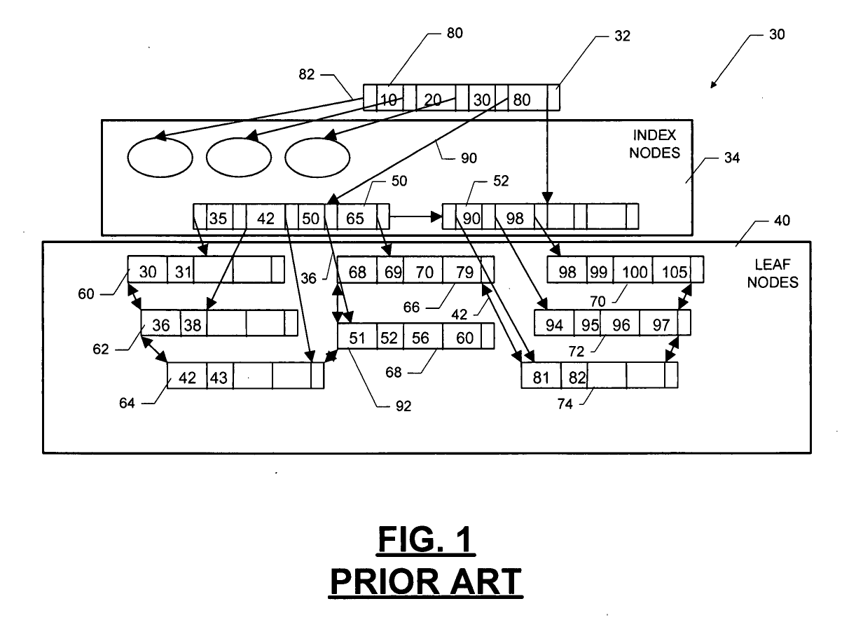

FIG. 2 is a block diagram of computer and software components capable of handling duplicate key values in a B-tree;

FIG. 3 is a block diagram containing example duplicate table values;

FIG. 4 is a block diagram of a duplicate key being used within the context of a B-tree environment;

FIG. 5 is a block diagram of multiple duplicate keys being used within the context of a B-tree environment;

FIG. 6 is a block diagram of computer and software components operating within a multithreaded environment;

FIG. 7 is a block diagram of multiple duplicate keys with variable length data being used within the context of a B-tree environment;

FIG. 8 is a B-tree diagram illustrating duplicate keys with example node values;

FIG. 9 is a flowchart depicting an operational scenario for accessing information in a B-tree;

FIG. 10 is a block diagram of computer and software components capable of handling duplicate key values in a networked environment; and

FIG. 11 is a block diagram depicting a metadata server accessing data records involving duplicate keys.

### DETAILED DESCRIPTION

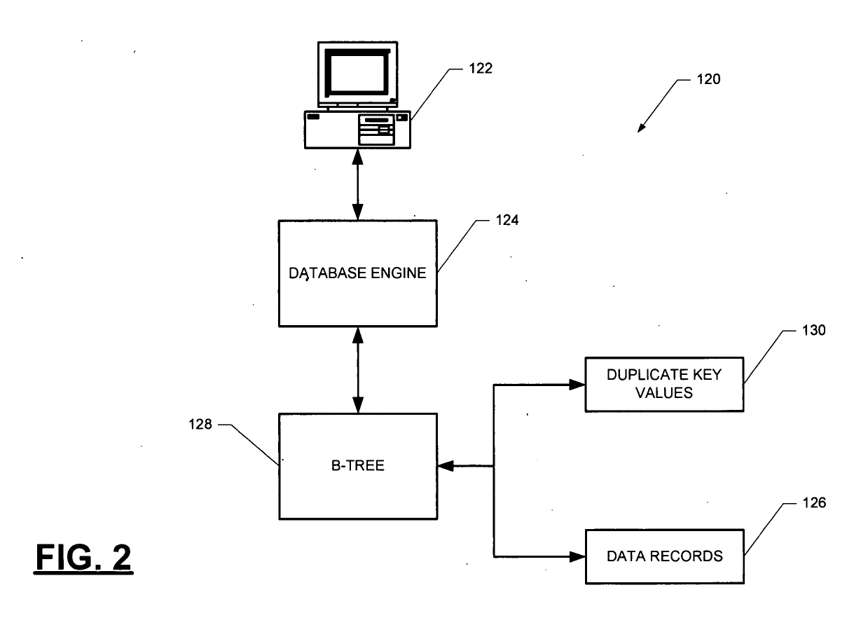

FIG. 2 depicts at 120 a system wherein a computer 122 utilizes a database engine 124 to access database records 126. To assist in more efficiently locating desired records, the database engine 124 includes a B-tree 128. If needed to search the data records 126, the B-tree 128 allows duplicate (e.g., identical) key values 130, each having a potential unique data record value.

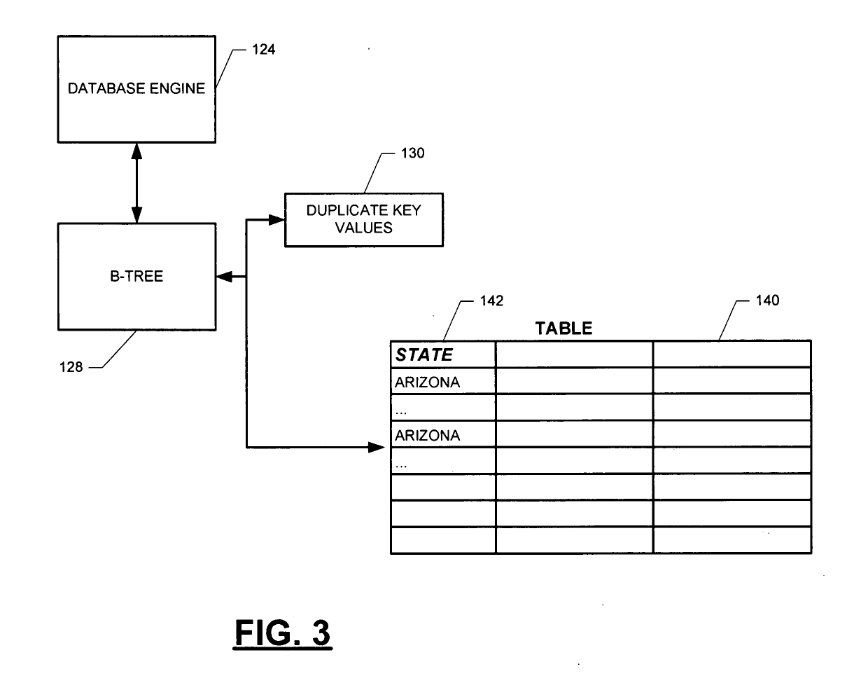

For example as shown in FIG. 3, duplicate key values 130 may be used to search table 140. The table 140 may have a column 142 named “state” that tracks the number of sales made in a state. In this example, the table 140 has the value “Arizona” appear multiple times in the state column 142 because multiple items were sold in the state of Arizona. To locate the records associated with the value “Arizona”, duplicate keys 130 point to the different “Arizona” values. A first key points to the first Arizona value in the table; a duplicate key then points to the next “Arizona” value. Duplicate keys are located until no more duplicate keys are located that correspond to an “Arizona” value. A vector is constructed of the duplicate keys and the records located using the vector.

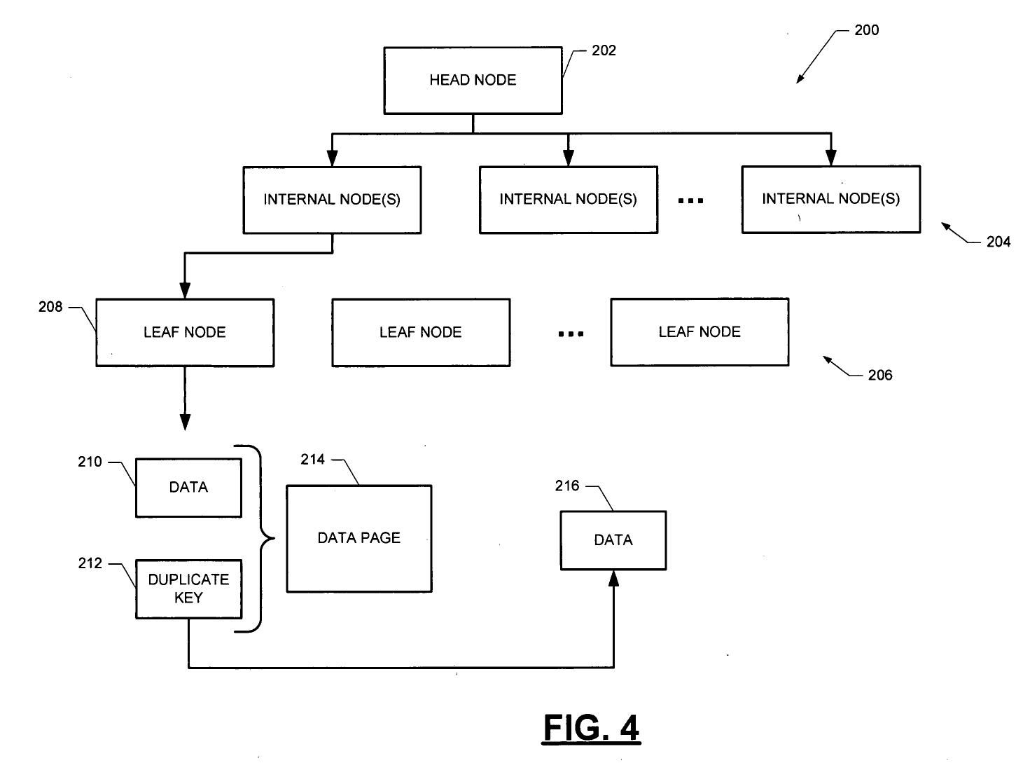

FIG. 4 illustrates a B-tree 200 that can handle duplicate keys. In the B-tree 200, a head node 202 points to internal (e.g., index) nodes 204 which point to leaf nodes 206. Leaf nodes 206 do not have children nodes. Additionally, the leaf nodes 206 do not contain the data but rather a pointer to the data and the next duplicate (if there is one). As an illustration, leaf node 208 points to data 210 and duplicate key 212. Duplicate key 212 points to the next duplicate 216. A duplicate key (e.g., 212) may be used because it is stored on data page 214 instead of the page containing leaf node 208. The storage on data pages also removes the limitation of the key from being a series of unique values; rather it allows an unlimited number of identical key values, each having a potential unique data value.

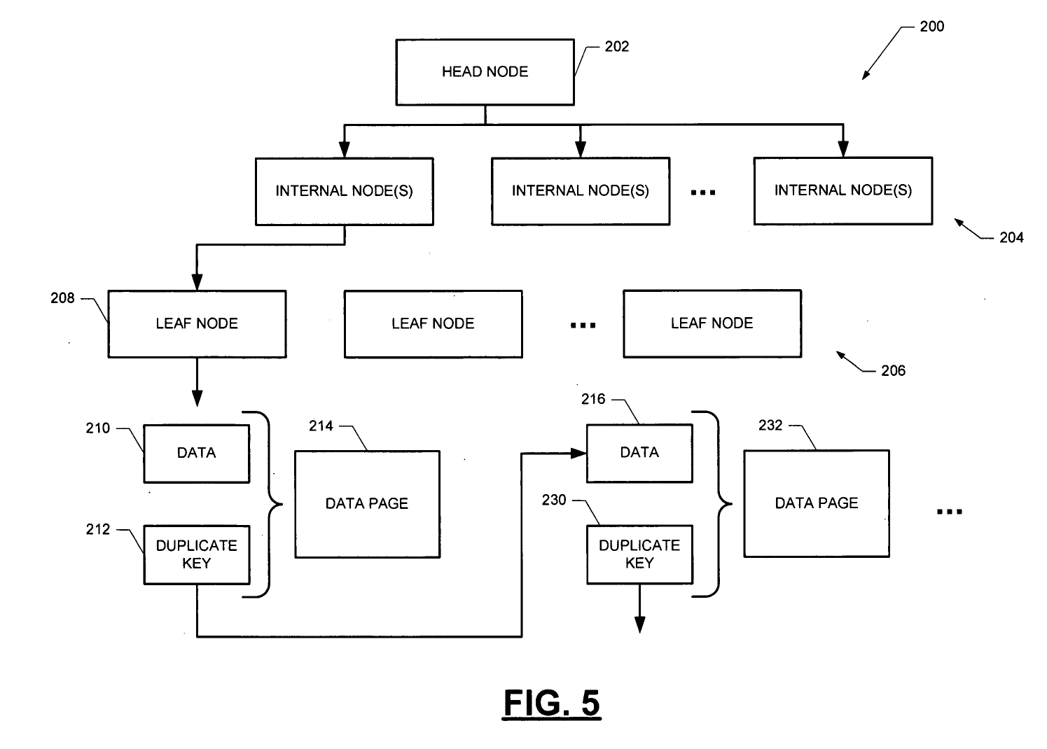

FIG. 5 shows an example where duplicate keys (212, 230) are placed on different data pages (214, 232) in the B-tree 200. Because they are placed on different data pages (214, 232), concurrently executing processes may manipulate the duplicate keys (212, 230) at approximately the same time without being locked out by another process.

Pages provide an organization mechanism for the B-tree 200. One or more nodes of the B-tree can be arranged to reside on a page. The page size may be selected, such as a 4 KB (kilobyte) page size, 8 KB, 64 KB, etc. To retrieve a page of data records, a page manager serves page requests. As an illustration, if page “10” is needed, the page manager will retrieve page “10” from disk and place it in memory. When the page is released, the page (and any changes) are written back to disk and removed from memory. A node's size may be adjusted so that an entire node can be loaded with exactly one disk operation, and then searched quickly in memory.

It should be understood that many different configurations are possible for a B-tree. For example if a duplicate key exists in the B-tree, the page and offset for the duplicate value may follow the data on the data page. If there are no duplicates, a null pointer is created.

As further examples of the different configurations possible, each page may have associated with it a lock handle; and because the tree is self-balancing, inserts do not need to lock the entire tree or path of the insert. Instead, only one lock is needed for most inserts to the leaf node.

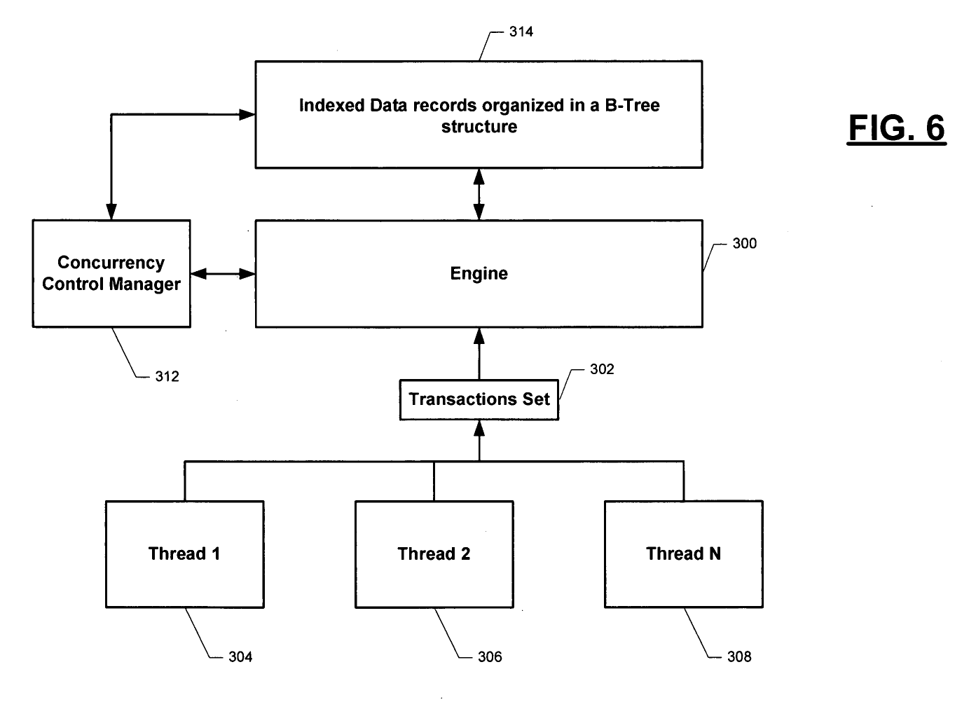

FIG. 6 shows the handling of duplicate keys in a dynamic multithreaded environment. With reference to FIG. 6, a database engine 300 implements a plurality of transactions 302 originating from concurrently operating threads (304, 306, 308). The database engine 300 concurrently locates and operates on the target data records 314 stored on the data pages. A concurrency-control manager 312 either internal to the database engine 300 or external implements a concurrency control protocol to manage accessing and locking of data pages due to the threads' transactions 302. The protocol takes into consideration the allowance of different processes manipulating substantially at the same time duplicate keys that are on different data pages. For example, while thread 304 is updating a key-value pair, thread 306 could be updating a duplicate key-value pair that is on a different page. The concurrency-control manager 312 would release the lock on a data page after the operation on the data page had completed so that another thread could access it.

The concurrency control protocol may assume many different types, such as a lock-based protocol wherein locks on index nodes and leaf nodes are released when the data page is identified. A non-limiting example of a lock-based approach to handle concurrency includes the use of spin-locks in a multi-threaded environment. This approach uses the native hardware's semaphore instructions to perform a busy wait (wherein a busy wait is a loop that continuously checks the availability of a shared memory location). A single thread can open a page for write, while the other processes would spin until the write thread releases the lock by changing the value of the lock.

A wide range of B-tree structures can incorporate the handling of duplicate keys in the manner disclosed herein, including B+ trees and B* trees (which are generally discussed in the following reference: R. Ramakrishnan et al., Database Management Systems, The McGraw-Hill Companies, Inc., Copyright 2000, pages 253-273).

The disclosed systems and methods for handling duplicate keys allow a B-tree to keep balanced and to maintain the number of entries in each node (except for the head node) between “d” and “2d” entries, where the number “d” is the order of the B-tree. It is noted that the term “balanced” typically refers to a B-tree's capability to be relatively shallow such that no node's subtree is much deeper (if at all) relative to another node's subtree.

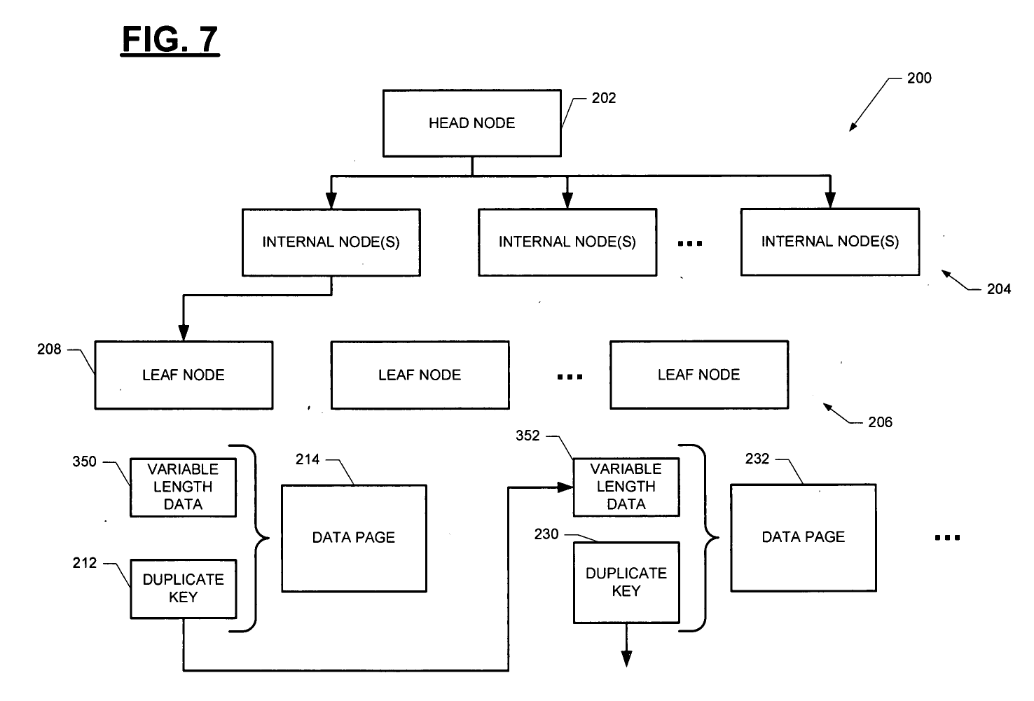

With reference to FIG. 7, each key-value pair could have an entirely different value and length. The placement of the data (350, 352, etc.) on data pages (214, 232, etc.) allows the data for each key-value pair to be variable length without affecting the degree of the leaf nodes 206 or requiring a resource-intensive garbage collection algorithm to have to constantly prune the tree of inefficiently used space, such as when deleting items from the tree.

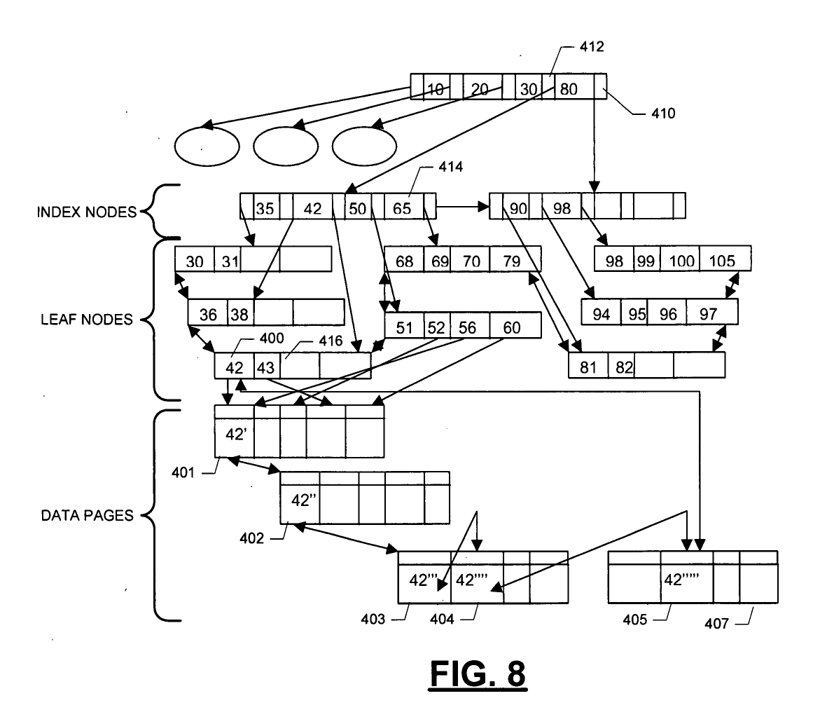

FIG. 8 provides an illustration where a B-tree has duplicate keys on data pages. In this example, the key “42” (shown at 400) has five unique values, in other words the key “42” (shown at 400) is duplicated five times (as shown at 401, 402, 403, 404, 405). If a transaction involves locating a key value of “42”, the key value can be located by proceeding from the head node 410 via the middle pointer 412 to index node 414 which itself points to leaf node 416. Key “42” (shown at 400) is located within the leaf node 416. Key “42” (shown at 400) points to the data and first duplicate key 401 that are located on a data page.

The first duplicate key 401 points to the next duplicate key 402 that is on a different data page, and so on, until the last duplicate key in this example is reached (i.e., key 405). It should be noted that two or more of the duplicate keys may reside on the same data page. Also, the links between the keys may be bi-directional. This allows find-backward operations as well as a find-forward operations. The leaf node 416 for the key “42” (shown at 400) may be expanded to include two pointers which point to the first record and last record.

The pages can be in-memory only or attached to a pageable file handler. The memory footprint may be specified at index creation-time or open file time. The B-tree can be persisted by closing the file that the pageable file handler is using to disk/page the pages not in-memory. At that point, all in-memory pages are written and the file is closed.

The system may create separate pages for index nodes, leaf nodes, and data pages. Each duplicate key may reside on different data pages or another configuration may be used, such as storing the first duplicate on a data page with the second duplicate being on a duplicate page; the remaining duplicates can also be placed on the duplicate page.

It should be understood that key values may be of numeric types or non-numeric types. An example of a non-numeric type would include a character string type. As an illustration, the keys could be letters of the English alphabet that facilitate the search for a person's name. Also, the data records may be of a wide range of types. Thus, numeric as well as non-numeric types of data records may be searched.

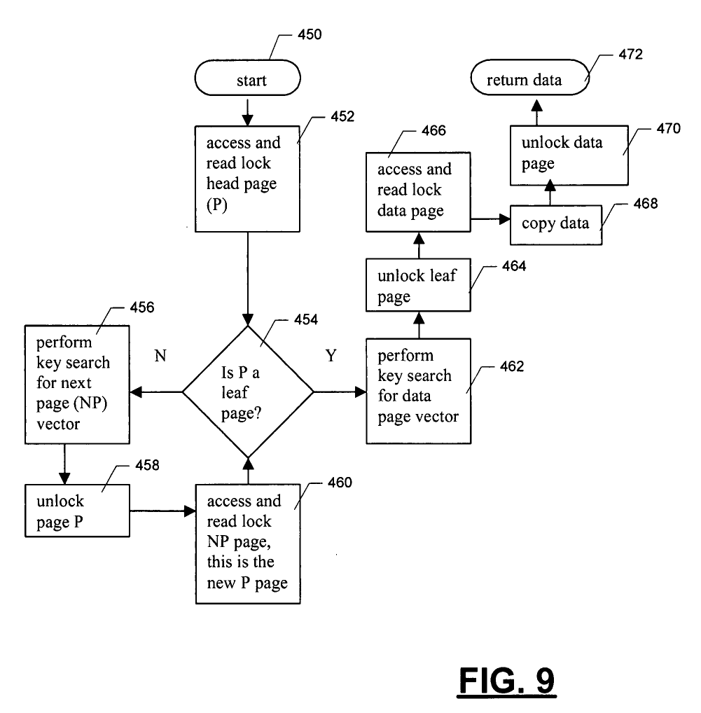

The systems and methods disclosed herein may utilize such B-tree operations as find( ), findnext( ), findprev( ), first( ) and last( ) as well as “traditional” user and computer searching interfaces. As an example, FIG. 9 depicts a searching operational scenario. Start indication block 450 indicates that at step 452, the head page (P) is accessed and a read lock is imposed upon the head page (P). Decision step 454 examines whether the current page (P) is a leaf page. Because at this point we are at the head page, processing proceeds at step 456 wherein a key search is performed for the next page (NP) vector. The page (P) is unlocked at step 458, and step 460 accesses the next page (NP) and establishes a read lock upon the next page (NP). The next page is considered the current page (P) for examination by decision step 454.

If the next page is still not a leaf page as determined by decision step 454, then processing resumes at step 456. However if the next page is a leaf page, then step 462 performs a key search for the data page vector. Step 464 unlocks the leaf page, and step 466 accesses the data page and establishes a read lock upon the data page. After the data of the data page is copied at step 468, the data page is unlocked at step 470, and the copied data is returned to the requestor as indicated at 472.

It should be understood that similar to the other processing flows described herein, the steps and the order of the steps in the flowchart of FIG. 9 may be altered, modified and/or augmented and still achieve the desired outcome. For example, the operational scenario may be augmented with such B-tree operations as findnext( ), findprev( ), first( ) and last( ). The find( ) function may also be modified to return the first occurrence (FIFO) of the key-value pair. Each subsequent findnext( ) or findprev( ) returns the next or previous key-value pair. During a read event, the leaf node can be unlocked once the data is located.

Still further, other operations can be performed, such as a delete operation. When a duplicate key-value pair is deleted, the value node (page and offset) is placed in a free chain along with the size of the deleted value. Appropriate housekeeping may add the available space to a free chain along with the size of the deleted value.

Another illustration involves an insertion operation with respect to a B-tree. Upon an insertion operation, the value node list may be searched for a best fit, and the space is reused, thereby limiting fragmentation and improving concurrent access to the underlying data. In the case of a node split, only three simultaneous page locks may be required: the node being split; the node being split's parent; and the new node that will acquire some of the information from the node being split. This holds true even if the split causes a cascade split all the way up to the head node that is being split. In this example, three index and leaf pages will be locked. If another thread is waiting on a write locked page, after the lock is released the search will continue. If the item is not found, the adjoining page (to the right) is searched. An operation (which moves right until found) readjusts the search and allows it to continue. If a duplicate is inserted, the previous pointer found on the leaf node indicates where the new duplicate should be inserted. Locks are maintained for each data page just like any other page.

As yet another illustration, an insert operation for a duplicate key may proceed as follows. With reference back to FIG. 8, if a sixth duplicate key (i.e., 42″″″) needs to be inserted, then a key search operation is performed in order to locate the pointer to the last duplicate key inserted involving that key. In this example, the pointer to 42″″′ (shown at reference number 405) would be obtained. The data page containing the last duplicate inserted is paged in (e.g., data page 407). The duplicate 42″″″ is inserted on the current duplicate data page (which may or may not be the same as data page 407). The pointers are rearranged so the last duplicate key inserted is pointed to by the key on the leaf page, and the key on the leaf page has both a pointer to the last duplicate key inserted and the first duplicate key inserted.

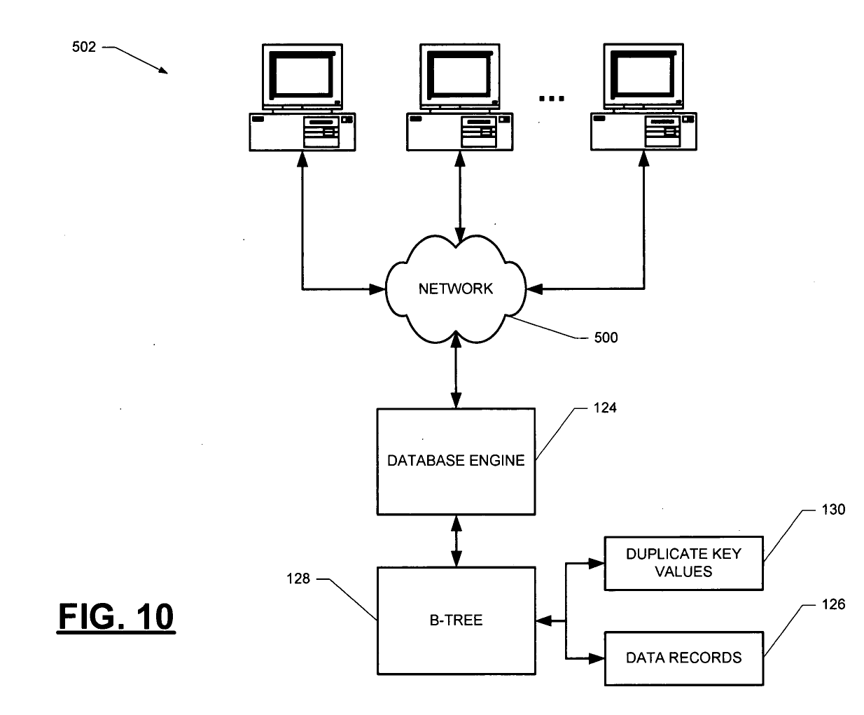

While examples have been used to disclose the invention, including the best mode, and also to enable any person skilled in the art to make and use the invention, the patentable scope of the invention is defined by the claims, and may include other examples that occur to those skilled in the art. As an illustration, the systems and methods disclosed herein may be implemented on various types of computer architectures, such as for example on a single general purpose computer or workstation as shown in FIG. 2, or on a network 500 (e.g., local area network, wide area network, or internet) as shown in FIG. 10 with a plurality of computers 502 accessing the data records 126. The computers 502 and the database engine 124 may be arranged in a client-server configuration.

Still further, the B-tree may be created in many different ways, such as in a non-duplicate mode. In that case the data page containing the data is returned to the caller. It is the caller's responsibility to update the page accordingly and then release the lock to the data page.

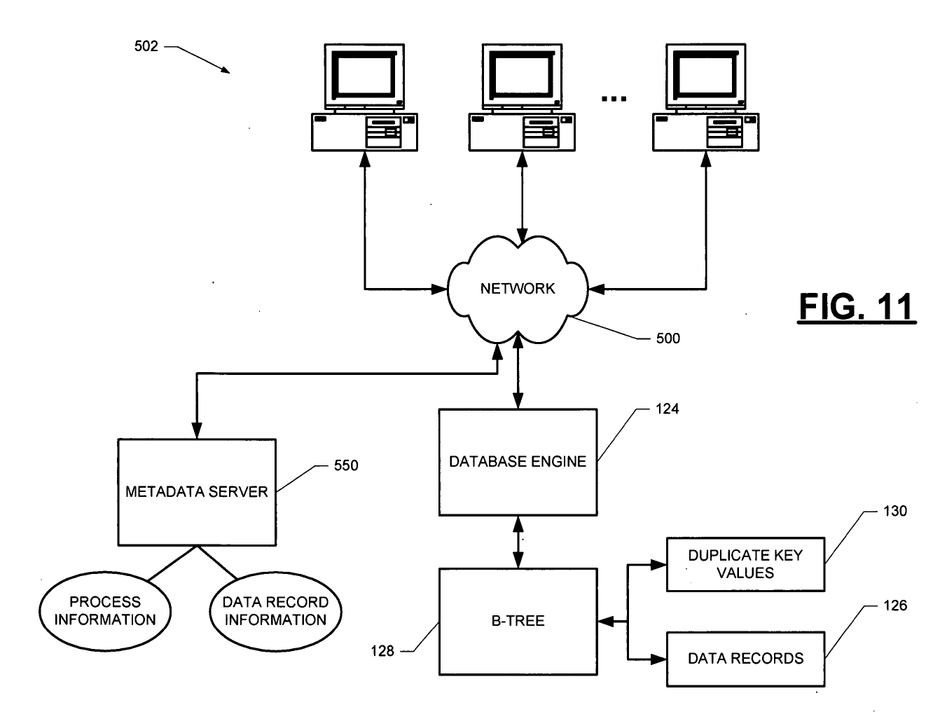

As yet another example of the many applications and extensions of the disclosed systems and methods, a broad range of client-server environments may use the systems and methods, such as an environment that includes a metadata server. The metadata server 550 as shown in FIG. 11 provides information about the data records 126 that are stored in the database. The metadata server 550 may also provide information about the processes that locate the data records via the B-tree 128 and perform operations upon the data records 126. The operations may include generating statistical analyses based upon the data records 126. Their access to the data records 126 may exhibit increased performance measurements due to the handling of the duplicate key values 130 as disclosed herein.

The metadata server 550 may indicate what data records 126 were accessed by which processes in addition to how well a process was able to statistically analyze the data records (e.g., if the statistical analysis included a linear regression operation, then the metadata server 550 would indicate how well the linear regression acts as a predictor of the data).

It is noted that the systems' and methods' data may be stored as one or more data structures in computer memory depending upon the application at hand. The systems and methods may be provided on many different types of computer readable media including instructions being executable by a computer to perform the system and method operations described herein.

The computer components, software modules, functions and data structures described herein may be connected directly or indirectly to each other in order to allow the flow of data needed for their operations. It is also noted that a software module may include but is not limited to being implemented as one or more sub-modules which may be located on the same or different computer. A module may be a unit of code that performs a software operation, and can be implemented for example as a subroutine unit of code, or as a software function unit of code, or as an object (as in an object-oriented paradigm), or as an applet, or as another type of computer code.

It should be further understood that as used in the description herein and throughout the claims that follow, the meaning of “a,” “an,” and “the” includes plural reference unless the context clearly dictates otherwise. Finally, as used in the description herein and throughout the claims that follow, the meanings of “and” and “or” include both the conjunctive and disjunctive and may be used interchangeably unless the context clearly dictates otherwise; the phrase “exclusive or” may be used to indicate situation where only the disjunctive meaning may apply.

1. A computer-implemented B-tree structure for information processing involving a database system with a plurality of data records, wherein a set of the data records have duplicate keys, comprising:
a plurality of interconnected nodes having a root node, index nodes and leaf nodes;
wherein a leaf node is configured to store a first key corresponding to first data in a first data page;
wherein the first data in the first data page is configured to store a second key that is a duplicate of the first key and that corresponds to second data stored on a second data page.

2. The B-tree structure of claim 1 wherein said first data page and second data page comprise the same page.

3. The B-tree structure of claim 1 wherein said first data page and second data page comprise different pages.

4. The B-tree structure of claim 1 wherein said first data and second data are the same.

5. The B-tree structure of claim 1 wherein said first data and second data are different.

6. The B-tree structure of claim 1 wherein said first data has variable length.

7. The B-tree structure of claim 1 wherein said second data has variable length.

8. The B-tree structure of claim 7 wherein degree of the leaf nodes is not substantially affected by the variable length of the first and second data.

9. The B-tree structure of claim 8 wherein degree of the leaf nodes is not substantially affected because the first and second data are stored separate from the leaf nodes.

10. The B-tree structure of claim 1 wherein said plurality of leaf nodes are maintained in sequential order and with a doubly linked list which connects each of said leaf node with its sibling nodes.

11. The B-tree structure of claim 10 wherein the B-tree is configured to operate with a find operation.

12. The B-tree structure of claim 10 wherein the B-tree is configured to operate with a find-next operation.

13. The B-tree structure of claim 10 wherein the B-tree is configured to operate with a find-previous operation.

14. The B-tree structure of claim 10 wherein the B-tree is configured to operate with a find-first operation.

15. The B-tree structure of claim 10 wherein the B-tree is configured to operate with a find-last operation.

16. The B-tree structure of claim 10 wherein the B-tree is configured to operate with an insert operation.

17. The B-tree structure of claim 10 wherein the B-tree is configured to operate with a delete operation.

18. The B-tree structure of claim 1 wherein data associated with the first and second keys are stored separate from the leaf nodes.

19. The B-tree structure of claim 1 wherein the first and second keys each have a corresponding unique data record value.

20. The B-tree structure of claim 1 wherein substantially concurrently executing processes update the first and second keys at approximately the same time without being locked out by another process because the first and second data are stored on different data pages.

21. The B-tree structure of claim 20 wherein the processes are threads.

22. The B-tree structure of claim 1 wherein page and offset for the second key's value follow the second data on the second data page.

23. The B-tree structure of claim 1 wherein each page has associated with it a lock handle, wherein because the B-tree is self-balancing, an insert operation to the B-tree avoids locking the entire B-tree or subtree.

24. The B-tree structure of claim 1 wherein the leaf nodes contain more than two key-value entries.

25. The B-tree structure of claim 1 wherein the second key is a duplicate key of the first key, wherein the second data is configured to store a third key that is a duplicate of the first key and that corresponds to third data stored on a third data page.

26. The B-tree structure of claim 1 wherein the second key is a duplicate key of the first key, wherein the second data is configured to store a third key that is a duplicate of the first key and that corresponds to third data stored on the second data page.

27. A computer-implemented method for concurrent execution of a plurality of transactions in a database system containing a plurality of data records, wherein a set of the data records have duplicate keys, said method comprising:
storing said plurality of data records in a B* tree structure with a plurality of index nodes and a plurality of leaf nodes, wherein each of said leaf nodes includes a plurality of elements each having a first pointer configured to store a first key corresponding to first data in a first data page;
wherein said first data further includes a second pointer configured to store a second key that is same as said first key and that corresponds to second data in a second data page;
implementing said plurality of transactions by concurrently locating and operating on the target data records stored in said data pages through use of said B* tree structure.

28. The method of claim 27 wherein said step of implementing said plurality of transactions further includes implementing a concurrency control protocol.

29. The method of claim 28 wherein the concurrency control protocol controls a first of said transactions to access first data in the first data page and concurrently a second of said transactions to access second data in the second data page, wherein said first data and second data have the same key.

30. The method of claim 28 wherein the concurrency control protocol is a lock-based protocol.

31. The method of claim 28 wherein the lock-based protocol releases locks on index nodes and leaf nodes when the data page is identified.

32. A computer-readable medium for concurrent execution of a plurality of transactions in a database system containing a plurality of data records, wherein a set of the data records have duplicate keys, comprising instructions for:
storing said plurality of data records within a B* tree structure that has a plurality of index nodes and a plurality of leaf nodes, wherein each of said leaf nodes includes a plurality of elements having a first pointer configured to store a first key corresponding to first data in a first data page;
wherein said first data further includes a second pointer configured to store a second key that is same as said first key and that corresponds to second data in a second data page;
implementing said plurality of transactions by concurrently locating and operating on the target data records stored in said data pages.

33. An information processing system in database application, comprising:
a plurality of data records with a first set of data records having duplicate keys, said plurality of data records stored in a B* tree structure with a plurality of index nodes and a plurality of leaf nodes, wherein each of said leaf nodes includes a plurality of elements having a first pointer configured to store a first key which corresponds to first data stored in a first data page;
wherein said first data includes a second pointer configured to store a second key that is a duplicate of the first key and that corresponds to second data in a second data page;
an engine for implementing a plurality of transactions by concurrently locating and operating on the data records stored in the data pages;
a concurrency-control manager for implementing a concurrency control protocol through use of the B* tree structure.
